(19) United States
(12) Patent Application Publication
(10) Pub. No.: US 2011/0006485 A1
(43) Pub. Date: Jan. 13, 2011

(54) SEALING DEVICE

(75) Inventor: Takehiro Nakagawa, Fukushima (JP)

Correspondence Address: HARNESS, DICKEY & PIERCE, P.L.C., P.O. BOX 828, BLOOMFIELD HILLS, MI, 48303, US

(73) Assignee: NOK CORPORATION, Tokyo (JP)

(21) Appl. No.: 12/921,510

(22) PCT Filed: Feb. 16, 2009
(86) PCT No.: PCT/JP2009/052464

§ 371 Date: Sep. 8, 2010

(30) Foreign Application Priority Data
Apr. 25, 2008 (JP) 2008-115176
Jul. 15, 2008 (JP) 2008-183862
Sep. 19, 2008 (JP) 2008-240573

(51) Int. Cl. F16J 15/32

(52) U.S. Cl. 277/549

(57) ABSTRACT

A sealing device (1) having an oil seal (10) mounted to non-rotatable housing (2) and also having a slinger (20) mounted to a rotating body (5) on the inner peripheral side of the oil seal (10) so as to be located on the axially outer side of the oil seal (10), the oil seal (10) having an oil-resistant seal lip (13) slidably in close contact with the outer peripheral surface of the rotating body (5), wherein a seal ring (30) axially opposed to the slinger (20) is provided outward of the oil-resistant seal lip (13), a gap (G₃) being formed between the seal ring (30) and the slinger (20) so as to decrease to the outer diameter side. The construction prevents muddy water etc. from entering from the outside (A) into a slide section (S₁) of the oil-resistant seal lip (13).

### CROSS-REFERENCE TO RELATED APPLICATIONS

This is a national stage of the International Application No. PCT/JP2009/052464 filed on Feb. 16, 2009 and published in the Japanese language. This application claims the benefit of Japanese patent Application Nos. 2008-115176 filed on Apr. 25, 2008, 2008-183862 filed on Jul. 15, 2008, and 2008-240573 filed on Sep. 19, 2008. The disclosures of the above applications are incorporated herein by reference.

### BACKGROUND OF THE INVENTION

1. Field of the Invention

The present invention relates to a sealing device sealing a shaft periphery and the like of a portion which tends to be exposed to muddy water or the like from an external portion, such as a transfer apparatus, a wheel bearing apparatus and the like of a vehicle, and more particularly to a sealing device provided with a structure preventing the muddy water or the like from making an intrusion into a sliding portion of an oil seal lip.

2. Description of the Conventional Art

Since a sealing device used for a transfer apparatus, a wheel bearing apparatus and the like of a vehicle is often exposed to splashed muddy water or the like from an external portion, it is necessary to inhibit the muddy water or the like from making an intrusion into a sliding portion of an oil seal lip as much as possible, thereby preventing a reduction of a sealing performance in the oil seal lip as much as possible. FIG. 9 is a half sectional view of an installed state and shows an example of this kind of sealing device in accordance with a conventional art by cutting along a plane passing through an axis O.

In particular, in FIG. 9, reference numeral 2 denotes a housing of a transfer apparatus, a wheel bearing apparatus or the like, reference numeral 3 denotes a rotating shaft which is inserted into the housing 2 and is supported in a state of being rotatable around an axis O via a bearing 4, reference numeral 5 denotes a sleeve which is spline fitted to an outer periphery of the rotating shaft 3 and is fixed by a nut 6, and reference numeral 7 denotes a packing which seals between the rotating shaft 3 and the sleeve 5. A companion flange 5a formed at an end portion of the sleeve 5 is connected to a propeller shaft not shown or the like.

A sealing device 100 is provided with a non-rotating oil seal 110 which is positioned at an outer side in an axial direction of the bearing 4 and is attached to an inner periphery of the housing 2, and a slinger 120 which is positioned at an outer side in the axial direction of the oil seal 110, is attached to an outer periphery of the sleeve 5, and is rotated integrally with the rotating shaft 3 and the sleeve 5.

Describing in detail, the oil seal 110 has an oil seal lip 111 which extends toward the bearing 4 side, and a side lip 112 and a dust lip 113 which extend toward an opposite side (an outer side) to the oil seal lip 111. The oil seal lip 111 is structured such as to prevent a lubricating oil fed to the bearing 4 from leaking by being slidably brought into close contact with an outer peripheral surface of the sleeve 5, the side lip 112 is structured such as to prevent muddy water or the like from making an intrusion into the oil seal lip 111 side by being slidably brought into close contact with a seal flange portion 121 of the slinger 120, and the dust lip 113 is structured such as to prevent muddy water or the like from making an intrusion into the oil seal lip 111 side by being slidably brought into close contact with an outer peripheral surface of the sleeve 5. The slinger 120 itself has a throwing off action on the basis of centrifugal force generated in the seal flange portion 121, and in addition, achieves an improvement of an effect of preventing the muddy water or the like from making an intrusion, by bringing an outer diameter portion 122 thereof into close contact with an end portion of the housing 2 (refer, for example, to Japanese Unexamined Patent Publication No. 2006-9930, Japanese Unexamined Utility Model Publication No. 5-54871 and Japanese Unexamined Utility Model Publication No. 3-67765), or by providing a conical tubular dust lip the diameter of which becomes large toward its end, on an outer diameter end portion of the slinger 120 so as to slidably come into close contact with the outer diameter edge portion thereof (refer, for example, to Japanese Utility Model Publication No. 7-33017).

However, in the conventional sealing device 100, it is not possible to inhibit an intrusion of muddy water in the case that the sealing device is submerged in the muddy water at a time of traveling on a punishing road. Accordingly, muddy water resistance is insufficient. Therefore, in order to improve muddy water sealing performance, it can be considered to increase the number of the side lip 112 and the dust lip 113, however, in this case, an attaching space of the sealing device 100 becomes large in size. Further, there is a risk that a sliding torque is increased and a fuel consumption rate is deteriorated.

Further, in case of the sealing device structured such that the outer diameter end portion of the slinger 120 is provided with the conical tubular dust lip the diameter of which becomes large toward its end as in Japanese Utility Model Publication No. 7-33017, since a body portion of the dust lip comes into close contact with an outer diameter edge of an opening end portion of the housing 2, while the housing 2 is generally manufactured by casting with a dimensional tolerance being great, a dispersion of a fastening margin of the dust lip is thus large with respect to the housing 2. In addition, such a problem is pointed out that, since the housing 2 made of the cast product has a rough surface, the dust lip tends to wear in an early stage.

### SUMMARY OF THE INVENTION

### Problem To Be Solved By the Invention

The present invention is made by taking the points mentioned above into consideration, and a technical object of the present invention is to provide a structure which can prevent muddy water or the like from making an intrusion into a sliding portion of an oil seal as much as possible, in a sealing device sealing a periphery or the like of a shaft of a portion which tends to be exposed to muddy water or the like from an external portion.

### Means For Solving the Problem

As a means for effectively solving the technical problem mentioned above, in accordance with a first aspect of the present invention, there is provided a sealing device comprising:

an oil seal attached to a non-rotating housing;

a slinger attached to a rotating body inserted into an inner periphery of the housing so as to be positioned at an outer side in an axial direction of the oil seal; and

an oil seal lip formed in the oil seal so as to be slidably brought into close contact with an outer peripheral surface of the rotating body,

wherein a seal ring opposed to the slinger in the axial direction is provided at an outer side of the oil seal lip, and is formed in such a manner that a gap between the seal ring and the slinger is made narrower toward an outer diameter side.

A sealing device in accordance with a second aspect of the present invention is structured such that the seal ring is integrally provided in the oil seal, in the structure described in the first aspect.

A sealing device in accordance with a third aspect of the present invention is structured such that the seal ring is attached to the housing so as to be positioned at an outer diameter side of the oil seal, is expanded in a radial direction, is retained to an outer diameter flange opposed to the slinger in the axial direction, and is elastically energized toward the slinger, in the structure described in the first aspect.

A sealing device in accordance with a fourth aspect of the present invention is structured such that the seal ring is constructed by an outer diameter flange which is attached to the housing so as to be positioned at an outer diameter side of the oil seal, and is expanded in a radial direction so as to be opposed to the slinger in the axial direction, and a conical wall, which makes a gap between opposed surfaces of the slinger and the outer diameter flange narrower toward an outer diameter side, is formed in at least one of the slinger and the outer diameter flange, in the structure described in the first aspect.

In accordance with a fifth aspect of the present invention, there is provided a sealing device comprising:

an oil seal attached to a non-rotating housing;

a slinger attached to a rotating body inserted into an inner periphery of the housing so as to be positioned at an outer side in an axial direction of the oil seal;

an outer diameter flange attached to the housing so as to be positioned at an outer diameter side of the oil seal and expanded in a radial direction so as to be opposed to the slinger in the axial direction;

an oil seal lip provided in the oil seal so as to be slidably brought into close contact with an outer peripheral surface of the rotating body; and

spiral grooves or spiral impeller blades being formed in one of the opposed surfaces of the slinger and the outer diameter flange so as to generate pump force toward the outer diameter side on the basis of rotation of the slinger.

A sealing device in accordance with a sixth aspect of the present invention is structured such that an outer diameter tube portion covering an outer periphery of the spiral groove or the spiral impeller blade and coming near to an outer diameter of the slinger is provided extendedly from an outer diameter end portion of the outer diameter flange, in the structure described in the fifth aspect.

A sealing device in accordance with a seventh aspect of the present invention is structured such that the slinger is provided with a side lip slidably brought into close contact with a reinforcing ring of the oil seal at an outer side of the oil seal lip, and the side lip extends in such a direction that a fastening margin with respect to the reinforcing ring is lowered by centrifugal force, in the structure described in the fifth aspect.

### Effect of the Invention

In accordance with the sealing device on the basis of a first aspect of the present invention, in the gap between the slinger and the seal ring which are opposed to each other in the axial direction at the outer side of the oil seal lip, a throwing off action is generated on the basis of the rotation of the slinger, a labyrinth seal action and a wedge effect on the basis of a dynamic pressure toward the outer diameter side are generated, and rejecting force applied to muddy water and a foreign material which are going to make an intrusion is enhanced in accordance with an increase of a rotating speed. Accordingly, it is possible to effectively prevent the muddy water from making an intrusion into the oil seal lip side from the outer side.

In accordance with the sealing device on the basis of a second aspect of the present invention, in addition to the effect obtained by the first aspect, since the seal ring is integrally provided in the oil seal, there can be obtained such an effect that an increase of the number of parts and an increase of manufacturing steps are not generated.

In accordance with the sealing device on the basis of a third aspect of the present invention, in addition to the effect obtained by the first aspect, there can be obtained such an effect that a dispersion is not generated with respect to the gap between the slinger and the seal ring even if an attaching error between the slinger and the oil seal exists.

In accordance with the sealing device on the basis of a fourth aspect of the present invention, between the opposed surfaces of the slinger and the outer diameter flange, the throwing off action is generated on the basis of the rotation of the slinger, and the labyrinth seal action and the wedge effect on the basis of the dynamic pressure toward the outer diameter side are generated, in the same manner as the first aspect. Therefore, it is possible to secure an excellent muddy water sealing function.

In accordance with the sealing device on the basis of a fifth aspect of the present invention, between the opposed surfaces of the slinger and the outer diameter flange, the throwing off action is generated on the basis of the rotation of the slinger, and in addition the spiral grooves or the spiral impeller blades formed in one of the opposed surfaces of the slinger and the outer diameter flange generate pump force toward the outer diameter side on the basis of the rotation of the slinger. Accordingly, it is possible to effectively remove muddy water and foreign material which are going to make an intrusion into the sliding portion side of the oil seal lip from the portion between the slinger and the outer diameter flange.

In accordance with the sealing device on the basis of a sixth aspect of the present invention, since the outer diameter tube portion extended from the outer diameter end portion of the outer diameter flange covers the outer periphery of the spiral grooves or the spiral impeller blades and comes near to the outer diameter of the slinger, a damming action is generated against discharge force generated by the spiral grooves or the spiral impeller blades. Accordingly, in addition to the effect obtained by the fifth aspect, it is possible to prevent the inner peripheral side of the spiral groove or the spiral impeller blade from becoming an excessively negative pressure.

In accordance with the sealing device on the basis of a seventh aspect of the present invention, in addition to the effect obtained by the fifth aspect since the side lip provided on the slinger increases the fastening margin with respect to the reinforcing ring at a low speed rotating time when the discharge force generated by the spiral grooves or the spiral impeller blades is low, it is possible to enhance the muddy water sealing function, and since the fastening margin with respect to the reinforcing ring is lowered at a high speed rotating time, it is possible to reduce a torque.

### BRIEF EXPLANATION OF DRAWINGS

FIG. 1 is a half sectional view of an installed state, and shows a first embodiment of a sealing device in accordance with the present invention by cutting along a plane passing through an axis O;

FIG. 2 is a half sectional view of an installed state, and shows a second embodiment of a sealing device in accordance with the present invention by cutting along a plane passing through an axis O;

FIG. 3 is a sectional view showing a substantial part in FIG. 2 in an enlarged manner;

FIG. 4 is a half sectional view of an installed state, and shows a third embodiment of a sealing device in accordance with the present invention by cutting along a plane passing through an axis;

FIG. 5 is a half sectional view of an installed state, and shows a fourth embodiment of a sealing device in accordance with the present invention by cutting along a plane passing through an axis;

FIG. 6 is a half sectional view of an installed state, and shows a preferable fifth embodiment of a sealing device in accordance with the present invention by cutting along a plane passing through an axis O;

FIG. 7 is a view of a slinger in accordance with the fifth embodiment as seen from a right side in FIG. 6;

FIG. 8 is a half sectional view of an installed state, and shows a preferable sixth embodiment of a sealing device in accordance with the present invention by cuffing along a plane passing through an axis O; and

FIG. 9 is a half sectional view of an installed state, and shows an example of a sealing device in accordance with a conventional art by cutting along a plane passing through an axis O.

### DETAILED DESCRIPTION OF PREFERRED EMBODIMENTS

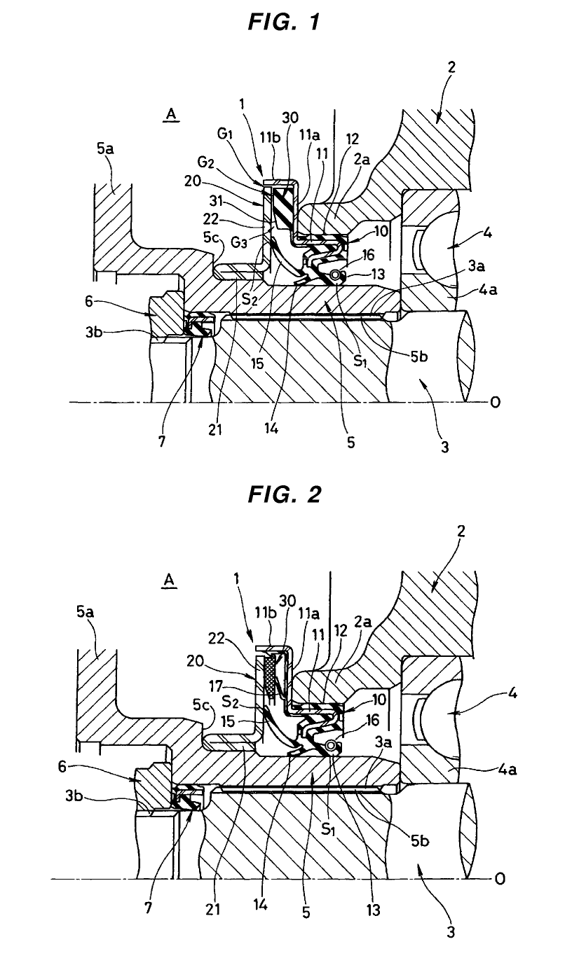

A description will be given below of a preferable embodiment of a sealing device in accordance with the present invention with reference to the accompanying drawings. FIG. 1 is a half sectional view of an installed state, and shows a first embodiment of the sealing device in accordance with the present invention by cutting along a plane passing through an axis O.

In this FIG. 1, reference numeral 2 denotes a non-rotating housing in a transfer apparatus of a vehicle, reference numeral 3 denotes a rotating shaft inserted into the housing 2 and supported in a state of being rotatable around an axis O via a bearing 4, and reference numeral 5 denotes a sleeve positioned at an inner peripheral side of an opening end portion 2a of the housing 2 and fitted onto the rotating shaft 3. In this case, the rotating shaft 3 and the sleeve 5 correspond to the rotating body described in the first aspect.

The sleeve 5 is structured such that a spline portion 5b which is formed in an inner peripheral surface thereof is fitted to a spline portion 3a which is formed in an outer peripheral surface of the rotating shaft 3, and is fixed in an axial direction by a nut 6 which is positioned at an outer side of the spline portions in the axial direction and is engaged with a male thread portion 3b formed on an outer peripheral surface of the rotating shaft 3 in a state in which an end is brought into contact with an inner ring 4a of the bearing 4. A portion between the rotating shaft 3 and the sleeve 5 is sealed by a packing 7 which is interposed at an outer side position in an axial direction of the fitted portion of the splines 3a and 5b, and is prevented by the nut 6 from coming off. Further, a companion flange 5a is formed at an outer end portion of the sleeve 5, and is connected to a propeller shaft not shown or the like.

Reference numeral 1 denotes a sealing device in accordance with the present invention. The sealing device 1 is provided with an oil seal 10 which is attached to an inner peripheral surface of the opening end portion 2a of the housing 2, a slinger 20 which is attached to an outer peripheral surface of the sleeve 5 fitted onto the rotating shaft 3 in a state of being positioned at an outer side in an axial direction of the oil seal 10, and a seal ring 30 which is attached to an outer periphery of the opening end portion 2a of the housing 2.

The oil seal 10 is integrally formed by a rubber material or a synthetic resin material having a rubber-like elasticity on a reinforcing ring 11 which is manufactured by punching press forming of a metal plate, and is provided with an outer peripheral seal portion 12 which is pressure inserted and fitted to the inner peripheral surface of the opening end portion 2a of the housing 2, an oil seal lip 13 which extends to the bearing 4 side from an inner diameter position of the reinforcing ring 11 and is slidably brought into close contact with the outer peripheral surface of the sleeve 5 by an inner peripheral portion in the vicinity of an end, a dust lip 14 which extends to an opposite side to the oil seal lip 13 from the inner diameter position of the reinforcing ring 11 and is opposed near to or is slidably brought into close contact with the outer peripheral surface of the sleeve 5 by an end inner periphery thereof, and a side lip 15 which extends to an opposite side to the oil seal lip 13 from an outer peripheral side of a root of the dust lip 14 and extends so as to form such a conical tubular shape that a diameter becomes larger toward its end portion. A garter spring 16 compensating tension force is fitly and attached to the oil seal lip 13.

An outer diameter flange 11a expanding like a disc shape in an outer diameter direction at an outer side of the opening end portion 2a of the housing 2 is extendedly provided in the reinforcing ring 11 of the oil seal 10, and a cylindrical outer diameter tube portion 11b directed to an opposite side to the opening end portion 2a of the housing 2 from an outer diameter end portion of the outer diameter flange 11a is extendedly provided. In other words, the outer diameter flange 11a (and the outer diameter tube portion 11b) are attached to the housing 2 by being provided integrally with the reinforcing ring 11 of the oil seal 10.

The slinger 20 is manufactured by punching press forming of a metal plate, and has an inner diameter tube portion 21 which is pressure fitted to the outer peripheral surface of the sleeve 5, and a seal flange portion 22 which expands like a disc shape in an outer diameter direction from the inner diameter tube portion 21 so as to be slidably brought into close contact with the end portion of the side lip 15 of the oil seal 10. An outer diameter end portion of the seal flange portion 22 comes near to and is opposed to an end inner peripheral surface of the outer diameter tube portion 11b, which extends from the reinforcing ring 11 of the oil seal 10, in a radial direction via a gap G in the radial direction.

A seal ring 30 is integrally provided on an opposed surface to the seal flange portion 22 of the slinger 20 in the outer diameter flange 11a extending from the reinforcing ring 11 of the oil seal 10. The seal ring 30 is integrally formed by a rubber material or a synthetic resin material having a rubber-like elasticity which is continuously provided from a root of the side lip 15 in the oil seal 10, and comes near to and is opposed to the seal flange portion 22 of the slinger 20 in the axial direction.

The seal ring 30 is formed to have such an inclined surface 31 that an inner diameter portion in the opposed surface to the seal flange portion 22 of the slinger 20 protrudes to the seal flange portion 22 side at an outer diameter side. Accordingly, an inner diameter side of a gap G₂ in the axial direction between the seal ring 30 and the seal flange portion 22 of the slinger 20 comes to a throttle gap G₃ which is narrowed toward the outer diameter side.

In the sealing device 1 in accordance with FIG. 1 constructed as mentioned above, the oil seal 10 is positioned and fixed to the housing 2, by pressure inserting the outer peripheral seal portion 12, in which the reinforcing ring 11 is embedded, into the inner peripheral surface of the opening end portion 2a until the outer diameter flange 11a of the reinforcing ring 11 comes into contact with the end surface of the opening end portion 2a of the housing 2. On the other hand, the slinger 20 is positioned and fixed to the sleeve 5 by pressure inserting and fitting the inner diameter tube portion 21 to the outer peripheral surface of the sleeve 5 and bringing the inner diameter tube portion 21 into contact with a step surface 5c formed in the outer peripheral surface of the sleeve 5, and thereafter the sleeve 5 is fitted onto the rotating shaft 3 so as to be fixed, whereby an illustrated installed state is achieved.

The oil seal lip 13 of the oil seal 10 is structured such as to prevent a lubricating oil fed to the bearing 4 from leaking to an external portion A from the outer periphery of the sleeve 5, at a sliding portion S₁ with the outer peripheral surface of the sleeve 5. Further, the side lip 15 of the oil seal 10 is structured such as to block an intrusion of a foreign material or muddy water into an inner peripheral side on the basis of a sliding motion in a close contact manner thereof with the seal flange portion 22 of the slinger 20 rotated integrally with the rotating shaft 3 and the sleeve 5 at a sliding portion S₂, and on the basis of a throwing off action of the seal flange portion 22 caused by centrifugal force, and the dust lip 14 of the oil seal 10 is structured such as to block an intrusion of the foreign material or the muddy water into the sliding portion S₁ side of the oil seal lip 13 by being opposed near to or being slidably brought into close contact with the outer peripheral surface of the sleeve 5 at an inner peripheral side of the side lip 15.

Further, at an outer side of the sliding portion of the oil seal lip 13, the dust lip 14 and the side lip 15, since a labyrinth seal action is generated by the gap G₁ in the radial direction between the outer diameter end portion of the seal flange portion 22 of the slinger 20 and the outer diameter tube portion 11b extended from the reinforcing ring 11 of the non-rotating oil seal 10, and the gap G₂ in the axial direction between the seal ring 30 retained by the outer diameter flange 11a of the reinforcing ring 11 and the seal flange portion 22 of the slinger 20, and in addition, since the inner diameter portion of the gap G₂ in the axial direction is formed as the throttle gap G₃ which is narrowed toward the outer diameter side, a wedge effect caused by a dynamic pressure is generated in a flow toward the outer diameter side generated by the throwing off action of the seal flange portion 22 caused by the centrifugal force. Therefore, it is significantly hard for the foreign material, the muddy water or the like coming from the external portion A makes an intrusion into the sliding portion S₂ between the seal flange portion 22 of the slinger 20 and the side lip 15 through the gaps G₁ to G₃.

Further, even if the foreign material, the muddy water or the like passes through the gaps G₁ to G₃, an amount thereof is extremely slight, and an intrusion of such the foreign material, the muddy water or the like into the inner peripheral side is inhibited on the basis of the throwing off action described previously at the sliding portion S₂ between the side lip 15 and the seal flange portion 22. Further, since the dust lip 14 exists in an inner side thereof, it is possible to effectively prevent an early abrasion caused by the intrusion of the muddy water or the foreign material into the sliding portion between the oil seal lip 13 and the sleeve 5, and it is possible to maintain an excellent oil sealing performance.

Further, since the seal ring 30 and the seal flange portion 22 of the slinger 20 are not in contact with each other, an increase of the sliding resistance by the seal ring 30 is not generated.

Further, since the seal ring 30 is formed integrally in the oil seal 10, an increase of the number of parts and an increase of manufacturing steps are not generated.

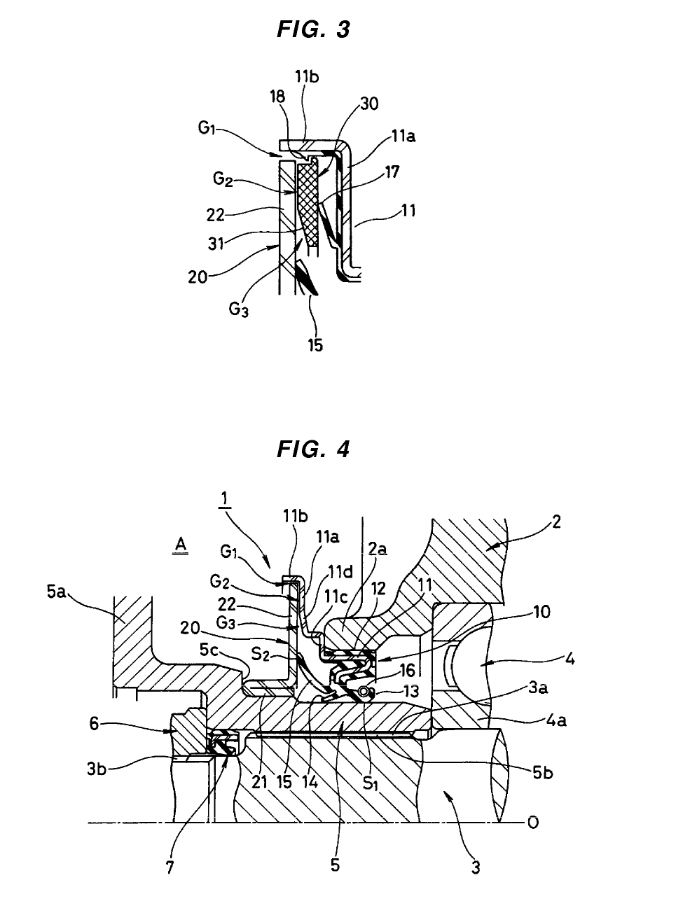

Next, FIG. 2 is a half sectional view of an installed state, and shows a second embodiment of a sealing device in accordance with the present invention by cutting along a plane passing through an axis O, and FIG. 3 is a sectional view showing a substantial part in FIG. 2 in an enlarged manner.

In the sealing device 1 in accordance with the second embodiment, a description will be given only of a different portion from the structure of the first embodiment described previously and shown in FIG. 1. The seal ring 30 is formed in an annular shape by a synthetic resin material which is excellent in an abrasion resistance and has a low friction coefficient, such as a PTFE (poly tetra fluoro ethylene)or the like, and is arranged between the outer diameter flange 11a extended from the reinforcing ring 11 of the oil seal 10, and the seal flange portion 22 of the slinger 20 which is opposed thereto in an axial direction.

As shown in FIG. 3, a lip-shaped spring 17 is integrally formed on the outer diameter flange 11a of the reinforcing ring 11 of the oil seal 10, and a locking protrusion 18 is integrally formed on an inner peripheral surface of the outer diameter tube portion 11b of the reinforcing ring 11, respectively by a rubber material or a synthetic resin material having a rubber-like elasticity which is continuously provided from a root of the side lip 15. Further, the seal ring 30 is elastically energized toward the seal flange portion 22 side of the slinger 20 by the lip-shaped spring 17, in a state of being prevented from coming off by the locking protrusion 18, thereby being retained to the outer diameter flange 11 a side and being slidably brought into contact with the seal flange portion 22 of the slinger 20 via the micro gap G₂ in the axial direction.

In this case, the lip-shaped spring 17 has a plural function serving as a means for sealing between the outer diameter flange 11a and the seal ring 30 by coming into close contact with the seal ring 30 by a suitable surface pressure and retaining the seal ring 30, as well as a means for elastically energizing the seal ring 30 toward the seal flange portion 22 of the slinger 20.

Further, the seal ring 30 is formed to have such an inclined surface 31 that an inner diameter portion in the opposed surface to the seal flange portion 22 of the slinger 20 protrudes to the seal flange portion 22 side at the outer diameter side. Accordingly, a throttle gap G₃ narrowing toward the outer diameter side is formed at an inner diameter side of the micro gap G₂ in the axial direction mentioned above.

In this case, the other portions can be basically structured in the same manner as FIG. 1 which is described previously.

In the sealing device 1 in accordance with the second embodiment structured as mentioned above, the oil seal lip 13, the dust lip 14, and the side lip 15 in the oil seal 10, the slinger 20, and the like have the same functions as those of the first embodiment, in an installed state shown in FIG. 2.

Further, at an outer side of the sliding portions of the oil seal lip 13, the dust lip 14 and the side lip 15, a labyrinth seal action is generated by the gap G₁ in the radial direction between the outer diameter end portion of the seal flange portion 22 of the slinger 20 and the outer diameter tube portion 11b of the reinforcing ring 11 of the oil seal 10, and the micro gap G₂ in the axial direction between the seal ring 30 and the seal flange portion 22 of the slinger 20, and in addition, since the throttle gap G₃ at the inner diameter side of the gap G₂ in the axial direction is narrowed toward the outer diameter side (the gap G₂ in the axial direction side), a wedge effect caused by a dynamic pressure is generated in a flow to the outer diameter side generated within the throttle gap G₃ on the basis of the throwing off action of the seal flange portion 22 generated by the centrifugal force. Therefore, it is significantly hard for the foreign material, the muddy water or the like coming from the external portion A to make an intrusion into the sliding portion S₂ between the seal flange portion 22 of the slinger 20 and the side lip 15 through the gaps G₁, G₂ and G₃.

Further, even if a slight attaching error in an axial direction is generated between the oil seal 10 and the slinger 20, the seal ring 30 is elastically energized toward the seal flange portion 22 of the slinger 20 by the lip-shaped spring 17. Accordingly, since a dispersion is not generated in the gaps G₂ and G₃ between the seal ring 30 and the seal flange portion 22, it is possible to secure a stable sealing performance.

Next, FIG. 4 is a half sectional view of an installed state, and shows a third embodiment of a sealing device in accordance with the present invention by cutting along a plane passing through an axis O.

In the sealing device 1 in accordance with the third embodiment, a description will be given of a different portion from the structures of the embodiments described previously. An annular step portion 11c exposed from the outer peripheral seal portion 12, the outer diameter flange 11a (and the outer diameter tube portion 11b) are provided to extend in an outer diameter portion of the reinforcing ring 11 of the oil seal 10. Describing in detail, the annular step portion 11c in the reinforcing ring 11 is structured such as to be brought into contact with an end surface of the opening end portion 2a of the housing 2, the outer diameter flange 11a is expanded in an approximately disc shape from the annular step portion 11c to the outer diameter side, and the outer diameter tube portion 11b is formed in a cylindrical shape which is directed to an opposite side to the opening end portion 2a of the housing 2 from an outer diameter end portion of the outer diameter flange 11a. In other words, the outer diameter flange 11a (and the outer diameter tube portion 11b) are attached to the housing 2 by being provided integrally in the reinforcing ring 11 of the oil seal 10.

The seal flange portion 22 of the slinger 20 is opposed in an axial direction to the outer diameter flange 11a in the reinforcing ring 11 of the oil seal 10 at its outer diameter side, and an outer diameter end portion in the seal flange portion 22 comes near to and is opposed to an inner peripheral surface of the outer diameter tube portion 11b extended from the outer diameter flange 11a via the narrow gap G₁ in the radial direction.

A conical wall 11d inclined to the seal flange portion 22 side of the slinger 20 is formed in a portion at an inner diameter side in the outer diameter flange 11a of the reinforcing ring 11 of the oil seal 10, a portion between the opposed surfaces of this conical wall 11d and the seal flange portion 22 opposed to each other in the axial direction is formed into a throttle gap G₃ which is narrowed toward the outer diameter side, and a portion between the throttle gap G₃ and the gap G₁ in the radial direction is formed into a narrow gap G₂ in the axial direction. In this case, it is preferable that the gap G₁ in the radial direction and the gap G₂ in the axial direction are set to be equal to or less than 3 mm for obtaining an effective labyrinth seal function.

In this case, the other portions can be basically structured in the same manner as each of the embodiments described previously.

In the sealing device 1 in accordance with the third embodiment structured as mentioned above, the oil seal lip 13, the dust lip 14, and the side lip 15 of the oil seal 10, the slinger 20 and the like have the same functions as those of each of the embodiments described previously, in an installed state shown in FIG. 4.

Further, at an outer side of the sliding portion S₂ of the side lip 15, a labyrinth seal action is generated by the gap G₁ in the radial direction between the outer diameter end portion of the seal flange portion 22 of the slinger 20 and the outer diameter tube portion 11b in the reinforcing ring 11 of the oil seal 10, the gap G₂ in the axial direction between the outer diameter flange 11a of the reinforcing ring 11 and the seal flange portion 22 of the slinger 20, and the throttle gap G₃ between the conical wall 11d at the inner peripheral side thereof and the seal flange portion 22. Further, since the throttle gap G₃ is narrowed toward the outer diameter side by the conical wall 11d of the reinforcing ring 11, a wedge effect caused by a dynamic pressure is generated in a flow toward the outer diameter side generated within the gap G₃ on the basis of the throwing off action of the seal flange portion 22 caused by the centrifugal force. Further, the action becomes more significant in accordance with an increase of a rotation speed. Accordingly, it becomes significantly hard for the foreign material, the muddy water or the like coming from the external portion A to make an intrusion into the slide portion S₂ between the seal flange portion 22 of the slinger 20 and the side lip 15 through the gaps G₁ to G₃.

Further, since the conical wall 11d of the reinforcing ring 11 is formed at the same time as that of press forming of the reinforcing ring 11, it is possible to hold down an increase of a manufacturing cost for obtaining the wedge effect by the throttle gap G₃ as mentioned above.

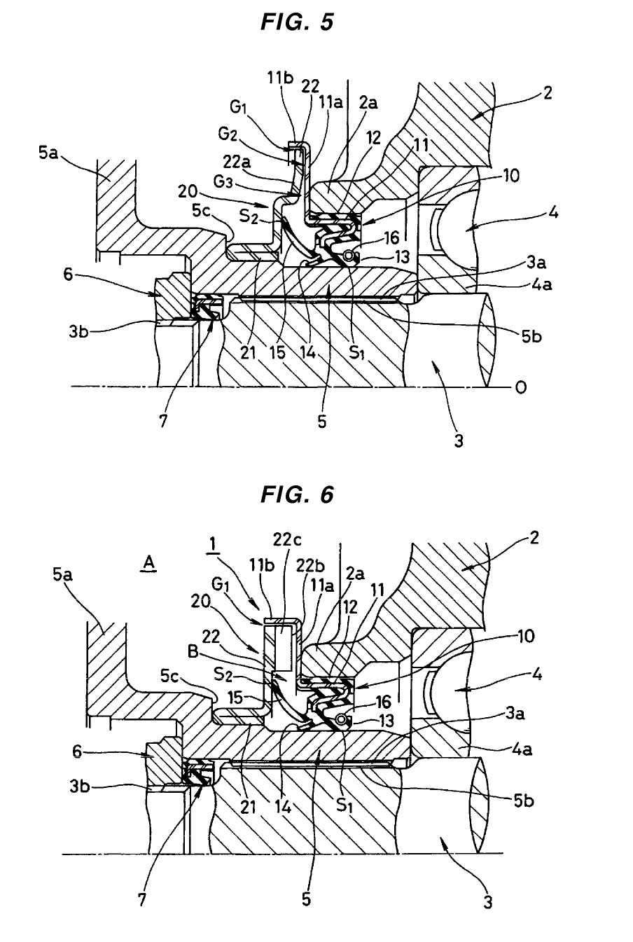

Next, FIG. 5 is a half sectional view of an installed state and shows a preferable fourth embodiment of a sealing device in accordance with the present invention by cutting along a plane passing through an axis O.

This fourth embodiment is different from the third embodiment described previously in a point that, in place of forming the conical wall in the outer diameter flange 11a extended from the reinforcing ring 11 of the oil seal 10, a conical wall 22a inclined to the outer diameter flange 11a side is formed in the seal flange portion 22 of the slinger 20 opposed to the outer diameter flange 11a formed in the disc shape, whereby the throttle gap G₃ which is narrowed toward the outer diameter side and the narrow gap G₂ in the axial direction at the outer diameter side thereof are formed between the outer diameter flange 11a and the seal flange portion 22. The other structures are basically the same as those of FIG. 4 described previously.

Accordingly, the fourth embodiment structured as mentioned above has the same functions as those of the third embodiment.

Further, since the conical wall 22a of the slinger 20 is formed at the same time as that of press forming of the slinger 20, it is possible to hold down an increase of a manufacturing cost for obtaining the wedge effect by the throttle gap G₃ as mentioned above.

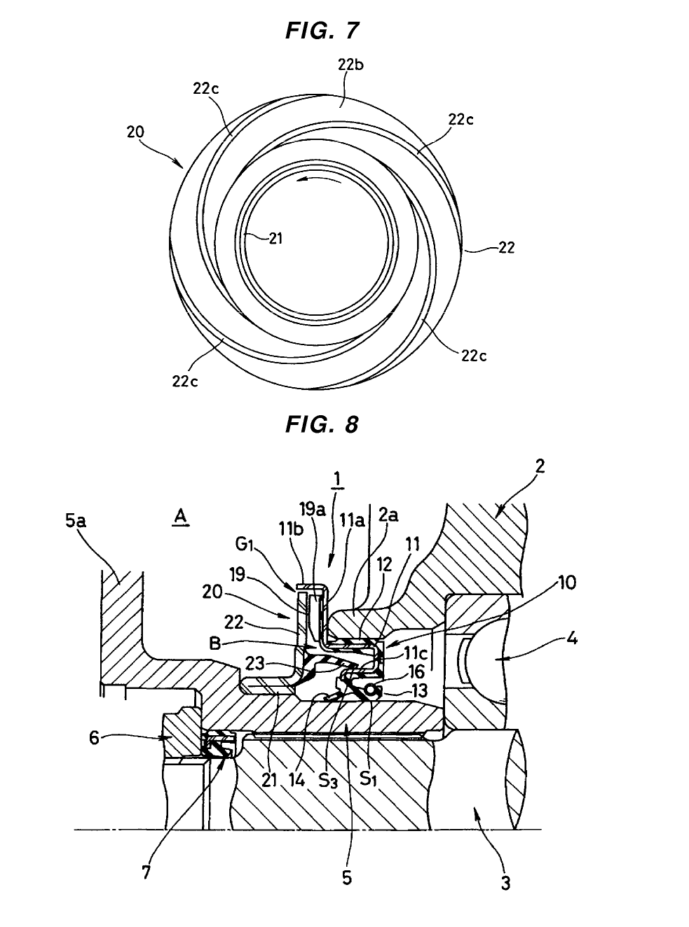

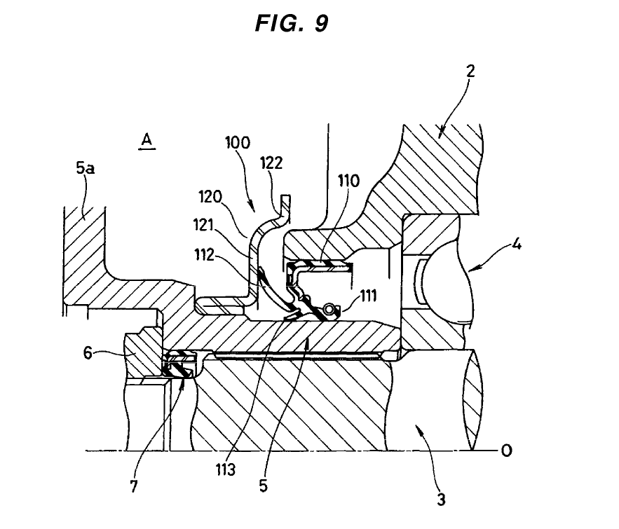

Next, FIG. 6 is a half sectional view of an installed state and shows a preferable fifth embodiment of a sealing device in accordance with the present invention by cutting along a plane passing through an axis O, and FIG. 7 is a view of a slinger in accordance with the fifth embodiment as seen from a right side in FIG. 6.

A description will be given of a different portion from the structure in each of the embodiments described previously, for the sealing device 1 in accordance with the fifth embodiment. An outer diameter portion of the reinforcing ring 11 of the oil seal 10 is provided extendedly with an outer diameter flange 11a and an outer diameter tube portion 11b which are exposed from the outer peripheral seal portion 12 made of a rubber or a synthetic resin material having a rubber-like elasticity. Describing in detail, the outer diameter flange 11a of the reinforcing ring 11 extends to an outer diameter side along an end of the opening end portion 2a of the housing 2, and the outer diameter tube portion 11b is formed in a cylindrical shape toward an opposite side to the opening end portion 2a of the housing 2 from an outer diameter end portion of the outer diameter flange 11a. In other words, the outer diameter flange 11a (and the outer diameter tube portion 11b) are attached to the housing 2 by being integrally provided in the reinforcing ring 11 of the oil seal 10.

An annular protruding portion 22b is formed on the seal flange portion 22 of the slinger 20 in such a manner that a portion at the outer diameter side of the slide portion S₂ with the side lip 15 of the oil seal 10 protrudes to an inner side in the axial direction, thereby coming near to and being opposed to the outer diameter flange 11a of the reinforcing ring 11 in the axial direction, and has a plurality of spiral grooves 22c formed in the opposed surface. The spiral grooves 22c are formed in such a curved shape as to extend in a direction capable of generating pump force toward the outer diameter side on the basis of the rotation of the slinger 20 in a counterclockwise direction in the figure, that is, in a shape that clockwise curves extend toward the outer diameter side direction, as shown in FIG. 7.

Further, the outer diameter tube portion 11b extending from the outer diameter flange 11a which is integrally formed with the reinforcing ring 11 of the oil seal 10 covers an outer periphery of the annular protruding portion 22b of the slinger 20 on which the spiral grooves 22c are formed, and comes near to and is opposed to the outer diameter of the slinger 20 (the seal flange portion 22).

In the sealing device 1 in accordance with the fifth embodiment structured as mentioned above, the oil seal lip 13, the dust lip 14, and the side lip 15 of the oil seal 10, the slinger 20 and the like have the same functions as those of each of the embodiments described previously, in the installed state shown in FIG. 6.

Further, at the outer side of the sliding portions of the oil seal lip 13, the dust lip 14 and the side lip 15, if the slinger 20 is rotated together with the rotating shaft 3 and the sleeve 5 in a counterclockwise direction in FIG. 7, pump force to the outer diameter side is generated by the spiral grooves 22c formed on the annular protruding portion 22b, in addition to the throwing off action generated thereby. Particularly, since the outer diameter tube portion 11b extending from the outer diameter flange 11a which is integrally formed with the reinforcing ring 11 of the oil seal 10 comes near to and is opposed to the outer diameter edge of the seal flange portion 22 of the slinger 20, the inside of the gap G₁ in the radial direction between the outer diameter tube portion 11b and the seal flange portion 22 is pressurized by the pump force so as to become a higher pressure than the external portion A. Accordingly, it is possible to effectively prevent the muddy water or the like coming from the external portion A from making an intrusion into the sliding portion S₂ of the side lip 15 through the gap G₁ in the radial direction. For example, even in the case that a vehicle travels in a state in which a whole of the portion shown in FIG. 6 is submerged in muddy water, it is possible to effectively prevent the muddy water in the external portion A from making an intrusion. Therefore, the side lip 15 is protected. As a result, it is possible to improve a dust sealing performance (a muddy water sealing performance) as a whole of the sealing device 1.

Further, since the outer diameter tube portion 11b extending from the outer diameter flange 11a which is integrally formed with the reinforcing ring 11 of the oil seal 10 comes near to and is opposed to the outer diameter edge of the seal flange portion 22 of the slinger 20, a flow in a discharge direction caused by the pump force generated in the spiral grooves 22c is suppressed in the gap G₁ in the radial direction. Accordingly, it is possible to prevent a space B between the spiral grooves 22c and the side lip 15 from becoming an excessive negative pressure.

Next, FIG. 8 is a half sectional view of an installed state, and shows a preferable sixth embodiment of a sealing device in accordance with the present invention by cutting along a plane passing through an axis O.

This sixth embodiment is different from the fifth embodiment described previously in a point that a spiral groove generating pump force to an outer diameter side on the basis of the rotation of the slinger 20 is formed at the outer diameter flange 11a side which is integrally formed with the reinforcing ring 11 of the oil seal 10, and a side lip 23 which is slidably brought into close contact with the reinforcing ring 11 at the outer side of the oil seal lip 13 and the dust lip 14 of the oil seal 10 is provided in the vicinity of an inner diameter portion in an inner side surface of the seal flange portion 22 of the slinger 20, in place of the side lip 15 shown in FIG. 6. The other structures are basically the same as those of FIG. 6.

Describing in detail, an opposed surface to the slinger 20 in the outer diameter flange 11a of the reinforcing ring 11 is provided integrally with an annular body 19 which is made of a rubber or a synthetic resin material having a rubber-like elasticity which is the same material as the oil seal lip 13 or the like, and a plurality of spiral grooves 19a are formed in the annular body 19. The spiral grooves 19a are formed in such a curved shape as to extend toward the outer diameter side with a curve in the same direction as the rotating direction of the slinger 20.

Further, a side lip 23 provided on the seal flange portion 22 of the slinger 20 is made of a rubber or a synthetic resin material having a rubber-like elasticity which is the same material as the oil seal lip 13 or the like, and is formed in such a conical tubular shape as to have a diameter which becomes smaller little by little toward an end at the oil seal 10 side, and an inner diameter of an end portion is slidably brought into close contact with an outer peripheral surface of the cylinder portion 11c formed in the vicinity of the inner diameter portion of the reinforcing ring 11 of the oil seal 10, thereby forming a sliding portion S₃.

In the sixth embodiment structured as mentioned above, the oil seal lip 13 of the oil seal 10, the dust lip 14 and the like have the same functions as those of each of the embodiments described previously.

Further, the side lip 23 which is provided on the seal flange portion 22 of the slinger 20 and is rotated integrally with the slinger 20 is structured such as to inhibit the muddy water or the like from making an intrusion into the inner peripheral side at the sliding portion S₃ with the cylinder portion 11c of the reinforcing ring 11.

Further, at the outer side of the sliding portions of the oil seal lip 13, the dust lip 14 and the side lip 23, if the slinger 20 is rotated together with the rotating shaft 3 and the sleeve 5, there is generated pump force to an outer diameter side by spiral grooves 19a formed in an annular body 19 provided on the outer diameter flange 11a of the reinforcing ring 11, in addition to the throwing off action generated thereby. Further, since the outer diameter tube portion 11b comes near to and is opposed to the outer diameter edge of the seal flange portion 22 of the slinger 20 in this embodiment, the inside of gap G₁ in the radial direction between the outer diameter tube portion 11b and the seal flange portion 22 is pressurized by the pump force so as to become a higher pressure than the external portion A. Therefore, it is possible to effectively prevent muddy water or the like coming from the external portion A from making an intrusion into the sliding portion S₃ of the side lip 23 through the gap G₁ in the radial direction. For example, even in the case that a vehicle travels in a state in which a whole of the portion shown in FIG. 8 is submerged in muddy water, it is possible to effectively prevent the muddy water in the external portion A from making an intrusion. Therefore, the side lip 23 is protected. As a result, it is possible to improve a dust sealing performance (a muddy water sealing performance) as a whole of the sealing device 1.

Further, since the outer diameter tube portion 11b extending from the outer diameter flange 11a which is integrally formed with the reinforcing ring 11 of the oil seal 10 comes near to and is opposed to the outer diameter edge of the seal flange portion 22 of the slinger 20, a flow in the discharge direction caused by the pump force generated in the spiral groove 19a is suppressed in the gap G₁ in the radial direction between the both. Accordingly, it is possible to prevent the space B between the spiral groove 19a and the side lip 23 from becoming an excessive negative pressure.

Further, since the side lip 23 rotating together with the slinger 20 increases the fastening margin with respect to the cylinder portion 11c of the reinforcing ring 11 at a low rotating time when the discharging force generated by the spiral groove 19a is low, it is possible to enhance the muddy water sealing function, and since the fastening margin is lowered by the discharging force generated by the spiral groove 19a and the centrifugal force of the side lip 23 itself at a high rotating time, it is possible to reduce the torque.

In this case, in the fifth and sixth embodiments mentioned above, the pump force is generated by the spiral groove 22c or the spiral groove 19a, however, the pump force may be generated by a spiral impeller blade. Further, in the case that the spiral impeller blade is provided at the slinger 20 side, a directionality thereof may be set in the same manner as the spiral groove 22c in FIG. 7, and in the case that it is provided at the outer diameter flange 11a side, the directionality thereof may be set in the same manner as the spiral groove 19a in the sixth embodiment.

1.-7. (canceled)

8. A sealing device comprising:
an oil seal attached to a non-rotating housing;
a slinger attached to a rotating body inserted into an inner periphery of said housing so as to be positioned at an outer side in an axial direction of said oil seal; and
an oil seal lip formed in said oil seal so as to be slidably brought into close contact with an outer peripheral surface of said rotating body,
wherein an outer diameter flange, which is expanded in a radial direction and is opposed to said slinger in an axial direction at an outer side of said oil seal lip, is attached to said housing so as to be positioned at an outer diameter side of said oil seal, and a conical wall, which makes a gap between opposed surfaces of the slinger and the outer diameter flange narrower toward an outer diameter side, is formed in at least one of said slinger and said outer diameter flange.

9. A sealing device comprising:
an oil seal attached to a non-rotating housing;
a slinger attached to a rotating body inserted into an inner periphery of said housing so as to be positioned at an outer side in an axial direction of said oil seal; and
an oil seal lip formed in said oil seal so as to be slidably brought into close contact with an outer peripheral surface of said rotating body,
wherein a seal ring which is opposed to said slinger with a micro gap in an axial direction at an outer side of said oil seal lip is retained to an outer diameter flange which is attached to said housing so as to be positioned at an outer diameter side of the oil seal and expanded in a radial direction, and is elastically energized toward said slinger, and the gap between the seal ring and said slinger is formed so as to be made narrower toward the outer diameter side.

10. A sealing device comprising:
an oil seal attached to a non-rotating housing;
a slinger attached to a rotating body inserted into an inner periphery of said housing so as to be positioned at an outer side in an axial direction of said oil seal;
an outer diameter flange attached to said housing so as to be positioned at an outer diameter side of said oil seal and expanded in a radial direction so as to be opposed to said slinger in the axial direction;
an oil seal lip provided in said oil seal so as to be slidably brought into close contact with an outer peripheral surface of said rotating body;
spiral grooves or spiral impeller blades formed in one of the opposed surfaces of said slinger and outer diameter flange so as to generate pump force toward the outer diameter side on the basis of rotation of said slinger; and
an outer diameter tube portion covering an outer periphery of the spiral grooves or the spiral impeller blades, coming near to an outer diameter of the slinger, and being provided extendedly from an outer diameter end portion of the outer diameter flange.

11. The sealing device as claimed in claim 10, wherein the slinger is provided with a side lip slidably brought into close contact with a reinforcing ring of the oil seal at an outer side of the oil seal lip and at an inner side of the spiral grooves or the spiral impeller blades, and the side lip extends in such a direction that a fastening margin with respect to said reinforcing ring is lowered by centrifugal force.
